(19) United States
(12) Patent Application Publication
(10) Pub. No.: US 2012/0323541 A1
(43) Pub. Date: Dec. 20, 2012

(54) SEISMIC IMAGING METHOD CONSIDERING A CONTOUR OF THE SEA BOTTOM

(75) Inventor: Changsoo SHIN, Seoul (KR)

(73) Assignee: SEOUL NATIONAL UNIVERSITY R&DB FOUNDATION, Seoul (KR)

(21) Appl. No.: 13/523,136

(22) Filed: Jun. 14, 2012

Related U.S. Application Data
(60) Provisional application No. 61/496,790, filed on Jun. 14, 2011.

(30) Foreign Application Priority Data
Jun. 14, 2012 (KR) 10-2012-0063898

(51) Int. Cl. G06F 17/11; G06F 17/16; G06F 17/10

(52) U.S. Cl. 703/2

(57) ABSTRACT

A seismic imaging method for imaging a subsurface structure is provided. The seismic imaging method calculates a coefficient matrix of a wave equation according to a contour of the sea bottom within a global grid. This method can be used to accurately estimate signals reflected on or transmitted through the sea bottom because it accurately reflects more detailed contours of the sea bottom within the global grid. Moreover, computational overburden is minimized.

### CROSS-REFERENCE TO RELATED APPLICATION

This application claims the benefit under 35 U.S.C. §119(a) of a U.S. Patent Application No. 61/496790, filed on Jun. 14, 2011, and a Korean Patent Application No. 10-2012-0063898, filed on Jun. 14, 2012,the entire disclosure of which is incorporated herein by reference for all purposes.

### BACKGROUND

1. Field

The following description relates to a seismic imaging technology for imaging a subsurface structure by processing measured data reflected from the subsurface structure after a wave from a source wave has been propagated to the subsurface structure.

2. Description of the Related Art

Technologies for imaging a subsurface structure through waveform inversion have been studied and developed. An example of such technologies is disclosed in a Korean Patent Registration No. 1,092,668 registered on Dec. 5, 2011, filed on Jun. 17, 2009 with the Korea Intellectual Property Office. The Korean Patent Registration has been filed as U.S. patent application Ser. No. 12/817,799 with the U.S. Patent and Trademark Office.

According to the disclosures, a low-frequency signal from a source is sent to a subsurface structure, a wave reflected from the subsurface structure is measured as measured data by a receiver such as a hydrophone array, and then the measured data is used to obtain a modeling parameter of the corresponding subsurface structure. The coefficients of a wave equation consist of modeling parameters such as the density, etc. of the subsurface space to which the wave is propagated. The modeling parameters of the wave equation are calculated by waveform inversion. According to the waveform inversion, the modeling parameters are calculated while being continuously updated in the direction of minimizing a residual function regarding the difference between modeling data and measured data, wherein the modeling data is a solution of the wave equation.

According to the disclosures above, a modeling parameter for a wave equation is obtained by updating the modeling parameter iteratively in the direction of minimizing a residual function regarding an error between modeling data and measured data, wherein the modeling data is a solution of the wave equation to which a coefficient matrix obtained from the modeling parameter has been applied. Further, to obtain the modeling parameter, firstly a coefficient matrix of the wave equation should be calculated from a modeling parameter. Then, solving the wave equation with the coefficient matrix and given source data yields the modeling data. is Next, a residual function regarding a residual between the measured data and the modeling data is calculated. If the value of the residual function is greater than a predetermined value, the modeling parameter of the wave equation is updated in the direction of minimizing the residual function. If the value of the residual function is smaller than the predetermined value, the modeling parameter at that iteration is outputted as a final output value. Conventional waveform inversion was performed on global grid basis and hence the sea bottom is modeled in conformity with these coarse grid points. This resulted in inaccurate estimation of signals reflected on or transmitted through the sea bottom.

### SUMMARY

The following description relates to a seismic imaging method that calculates a coefficient matrix of a wave equation according to a contour of the sea bottom within a global grid. This method can be used to accurately estimate signals reflected on or transmitted through the sea bottom because it accurately reflects more detailed contours of the sea bottom within the global grid. Moreover, computational overburden is minimized.

In one general aspect, the coefficient matrix is calculated from a mass matrix which is obtained by applying a numerical integration method to two domains, the first domain being an upper medium above the sea bottom and the second domain being a lower medium below the sea bottom.

According to another aspect, the numerical integration method is Gaussian Quadrature Integration Method. Other features and aspects will be apparent from the following detailed description, the drawings, and the claims.

### BRIEF DESCRIPTION OF THE DRAWINGS

is FIG. 1 is a flow chart illustrating an example of a seismic imaging method.

FIG. 2 illustrates a 2D cross-sectional diagram of two cubic elements divided by the sea bottom.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

An example of a seismic imaging method includes waveform inversion. According to an aspect, an embodiment of the waveform inversion obtains a modeling parameter for a wave equation by updating the modeling parameter iteratively in the direction of minimizing a residual function regarding an error between modeling data and measured data, wherein the modeling data is a solution of the wave equation to which a coefficient matrix obtained from the modeling parameter has been applied, and the measured data has been measured by a plurality of receivers,

An exemplary but not limiting waveform inversion in the Laplace domain is disclosed in Shin, C. S., & Cha, Y. H., 2008. Waveform inversion in the Laplace domain, Geophys. J. Int., is 173, 922-931. According to the papers above, the Laplace-transformed wavefield in the time domain is expressed by

\tilde{u}(s)=∫₀^{∞}u(t)e^{-st} dt (1)

where \tilde{ũ}(s) is the wavefield in the Laplace domain, u(t) is the wavefield in the time domain, t is time, and s is the Laplace damping constant. Then wave equation in the Laplace domain can be obtained by transforming a wave equation in the time domain into the Laplace domain:

$$\frac{{s}^{2}}{{c}^{2}} \frac{{\partial }^{2} \tilde{u}}{\partial {t}^{2}} = \frac{{\partial }^{2} \tilde{u}}{\partial {x}^{2}} + \frac{{\partial }^{2} \tilde{u}}{\partial {y}^{2}} + \frac{{\partial }^{2} \tilde{u}}{\partial {z}^{2}} + {\tilde{f}}_{,} \qquad ( 2 )$$

where c (x, y, z) is the p-wave velocity, u (x, y, z, t) is the pressure field, and f (x, y, z, t) is the source function, and hat notation above a letter indicates a Laplace transformed variable.

The wave equation in the Laplace domain above can be solved by the finite element method. We apply the weighted residual method to derive a modified formula equivalent to the wave equation. We define the residual to apply the weighted residual method in equation (2) as

$$r = \frac{{s}^{2}}{{c}^{2}} \frac{{\partial }^{2} \tilde{u}}{\partial {t}^{2}} - {∇}^{2} \tilde{u} - \tilde{f} , \qquad ( 3 )$$

where ∇ is the Laplace operator defined as

$$\frac{{\partial }^{2}}{\partial {x}^{2}} + \frac{{\partial }^{2}}{\partial {y}^{2}} + \frac{{\partial }^{2}}{\partial {z}^{2}} .$$

We change equation (3) to the weak form by multiplying it by an arbitrary weighting function, v and integration in a given domain, Ω.

$${\int }_{Ω} [ \frac{{s}^{2}}{{c}^{2}} \tilde{u} - {∇}^{2} \tilde{u} - \tilde{f} ] v d Ω = 0 , \qquad ( 4 )$$

By integration by parts of Equation (4) and applying the natural boundary condition, equation (4) becomes :

$${\int }_{Ω} [ \frac{{s}^{2}}{{c}^{2}} \tilde{u} v - ∇ \tilde{u} ∇ v - \tilde{f} v ] d Ω = 0 \qquad ( 5 )$$

The Laplace-transformed wavefields, ũ and v are approximated by summation of weight functions αⱼ (s) and βᵢ (s), and basis functions, φⱼ (x, y, z) and φᵢ (x, y, z) by the Galerkin approximation as follows:

$$u ( x , y , z , s ) = {\sum }_{j = 1}^{N} {α}_{j} ( s ) {φ}_{j} ( x , y , z ) , and \\ v ( x , y , z , s ) = {\sum }_{i = 1}^{N} {β}_{j} ( s ) {φ}_{i} ( x , y , z ) , \qquad ( 6 )$$

By substituting equation (6) into equation(5), assuming the arbitrary function ν=1 and rearranging, we obtained

$${\sum }_{j = 1}^{N} {s}^{2} \frac{{α}_{j}}{{c}^{2}} {\sum }_{i = 1}^{N} {\int }_{Ω} ( {φ}_{j} {φ}_{i} ) d Ω + {\sum }_{j = 1}^{N} {α}_{j} {\sum }_{i = 1}^{N} {\int }_{Ω} ( \frac{\partial {φ}_{j}}{\partial x} \frac{\partial {φ}_{i}}{\partial x} + \frac{\partial {φ}_{j}}{\partial y} \frac{\partial {φ}_{i}}{\partial y} + \frac{\partial {φ}_{j}}{\partial z} \frac{\partial {φ}_{i}}{\partial z} ) d Ω = \tilde{f} {\sum }_{i = 1}^{N} {\int }_{Ω} {φ}_{i} d Ω \qquad ( 7 )$$

Letting the coefficients of the basis functions, αⱼ be a vector, ũ, because these coefficients fundamentally represent wavefields, we can convert equation (7) to a matrix multiplication form as follows:

$$\begin{matrix}S \tilde{u} = \tilde{f} where \\ S = K + {s}^{2} M \\ K = {K}_{ij} = {\int }_{Ω} ( \frac{\partial {φ}_{j}}{\partial x} \frac{\partial {φ}_{i}}{\partial x} + \frac{\partial {φ}_{j}}{\partial y} \frac{\partial {φ}_{i}}{\partial y} + \frac{\partial {φ}_{j}}{\partial z} \frac{\partial {φ}_{i}}{\partial z} ) d Ω , and & ( 8 ) \\ M = {M}_{ij} = {\int }_{Ω} ( \frac{1}{{c}^{2}} {φ}_{j} {φ}_{i} ) d Ω & ( 9 )\end{matrix}$$

In equation (9)Error! Reference source not found., M is a mass matrix and K is a is stiffness matrix. We can obtain the wavefield in the Laplace domain by solving equation (8) as described in equation (10).

ũ=S⁻¹\tilde{f} (10)

FIG. 1 is a flow chart illustrating an example of a seismic imaging method. As described in U.S. patent application Ser. No. 12/817,799, a modeling parameter for a wave equation is obtained by updating the modeling parameter iteratively in the direction of minimizing a residual function regarding an error between modeling data and measured data, wherein the modeling data is a solution of the wave equation to which a coefficient matrix obtained from the modeling parameter has been applied. As shown in FIG. 1, to obtain the modeling parameter, firstly a coefficient matrix of the wave equation should be calculated from a modeling parameter(steps 100˜300). Then, solving the wave equation with the coefficient matrix and given source data yields the modeling data(step 400). Next, a residual function regarding a residual between the measured data and the modeling data is calculated(step 500).

Disclosed in detail is the calculation of the residual function in Pyun, S. J., Shin, C. S. & Bednar, J. B., 2007. Comparison of waveform inversion, part3: amplitude approach, Geophys. Prospect., 55, 465-475. Also, Shin, C. S., & Min, D. J., 2006. Waveform inversion using a is logarithmic wavefield: Geophysics, 71, R31-R42. Discloses a logarithmic residual function.

Next, the value of the residual function is compared with a reference value R_{ref}(step 600). If the value of the residual function is greater than a predetermined value, the modeling parameter of the wave equation is updated in the direction of minimizing the residual function(step 700).

To determine the direction of minimizing the residual function, a gradient of the residual function is calculated. The Gauss-Newton method, the Marquardt-Levenverg method, the steepest decent method and other least-square methods that seek to minimise the cumulative squared residuals with respect to changes in the parameter can be applied to this minimisation problem. A back-propagation algorithm may be used to calculate the direction of the gradient of the k-th element more effectively (Shin & Min 2006 above). Again, the coefficient matrix of the waveform equation is calculated using the updated modelling parameter(step 200). These iteration continues until the value of the residual function becomes smaller than the predetermined reference value R_{ref}. If the value of the residual function is smaller than the predetermined value, the modeling parameter at that iteration is outputted as a final output value(step 800).

According to an aspect, the coefficient matrix is calculated from a mass matrix obtained according to the contour of the sea bottom within a global grid near the sea bottom. According to another detailed aspect, the mass matrix is obtained by applying a numerical integration method to two domains, the first domain being an upper medium above the sea bottom and the second domain being a lower medium below the sea bottom.

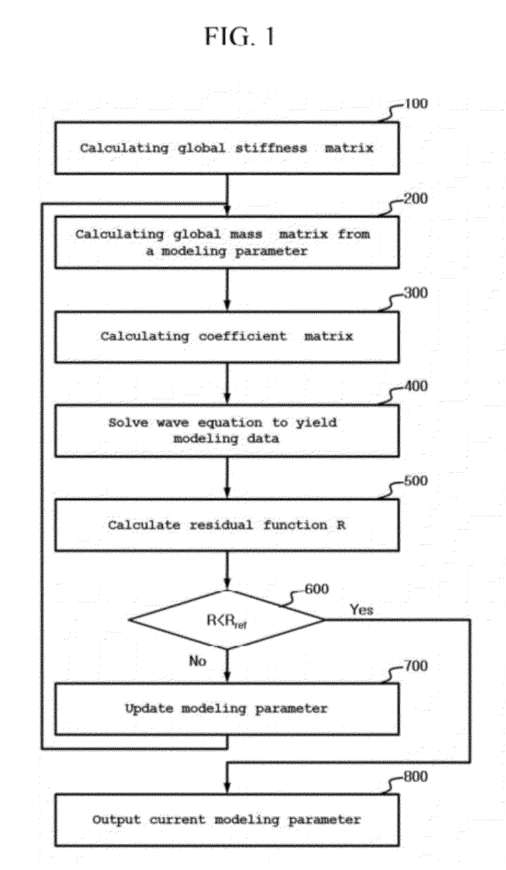

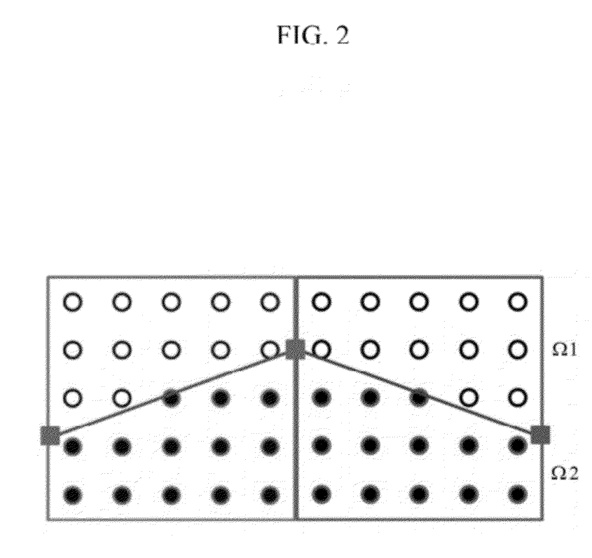

FIG. 2 illustrates a 2D cross-sectional diagram of two cubic elements divided by the sea bottom. Each of the cubic elements are identified by global grids. The obliquely inclined lines or interfaces that connect the three square dots represent the assumed sea bottom and these is lines divide the extended numerical integration points (circles) into the different two groups (Ω1 and Ω2). The element mass matrix can be calculated by a numerical integration method using two different model velocities assigned to each group, Ω1 and Ω2.

As for the cubic elements above the sea bottom, corresponding medium is water and the modeling parameter, for example, concentration or the propagation velocity for the cubic elements is assumed to be constant. Hence numerical integration method disclosed herein does not need to be applied. For at least some of the cubic elements along the sea bottom surface, especially for obliquely interfaced cubic elements where signal propagation may be distorted, numerical integration method disclosed herein need to be applied. This greatly reduces the number of cubic elements where extended numerical integration should be applied at each iteration, hence reduces greatly the errors caused by irregular sea bottom surface with minimum added computational burden of the whole seismic imaging. For 3-dimensional seismic imaging where computational burden is already high and affected more sensitively by the sea bottom configuration, these aspects are more important compared to 2-dimensional or 1-dimensional seismic imaging.

According to another aspect, the numerical integration method may be the Gaussian Quadrature Integration Method. The Gaussian quadrature integration method is a numerical integration method that expresses the one-dimensional integration of an (2n+1) -th order arbitrary function as a linear combination of n integration point coordinates and their corresponding weights.

According to an aspect, the Gaussian quadrature integration method is applied to calculate the element mass matrices that constitute the impedance matrix in the Laplace-domain modelling and inversion algorithm at elements along the sea bottom. By the Gaussian quadrature integration method, we can express the element mass matrix of equation (9) as equal is to the right side of equation (11) as follows:

$${M}_{ij}^{e} = {\int }_{{Ω}_{e}} {φ}_{i} {φ}_{j} d {Ω}_{e} = {\int }_{- 1}^{1} {\int }_{- 1}^{1} {\int }_{- 1}^{1} \frac{{h}^{3}}{8 {c}^{2}} {φ}_{i} {φ}_{j} d ξ d η d ζ = {\sum }_{p = 1}^{n} {\sum }_{q = 1}^{n} {\sum }_{r = 1}^{n} {w}_{p} {w}_{q} {w}_{r} F ( {ξ}_{p} , {η}_{q} , {ζ}_{r} ) \qquad ( 11 )$$

In equation (11), Mᵢⱼ^{e} is an element mass matrix, p,q,r is indices of the Gaussian quadrature points in 3-dimensional domain, h is a grid interval. Φᵢ, Φⱼ are values of shape function at i-th and j-th nodes. Each of the shape functions has a value of ‘1’ at a grid point and has values of ‘0’ at all the other points. All of the shape functions have values of ‘1’ at different grid points. The local coordinates of an integration point are ξₚ, η_{q}, and ζᵣ, and F(ξₚ, η_{q}, ζᵣ) is the value of the multiplication of shape functions at the local coordinates.

Because the velocity, c is a function of space, it is not constant within an element at the sea bottom when the grid interval is coarse enough for the sea bottom to pass through the element. However, the conventional 3D Laplace-domain modelling technique has a resolution problem because it describes the different velocities in a single element as one velocity. To reflect two velocities in one element, we use different F (ξₚ, η_{q}, ζᵣ) values corresponding to the velocity of each Gaussian quadrature point (ξₚ, η_{q}, ζᵣ) when integrating the mass matrix of the element at the sea bottom as follows:

$$F ( {ξ}_{p} , {η}_{q} {ζ}_{r} ) = \{ \begin{matrix}\frac{{h}^{3}}{8 {c}_{Ω 1}^{2}} {φ}_{i} {φ}_{j} & if ( {ξ}_{p} , {η}_{q} , {ζ}_{r} ) ⋐ Ω 1 \\ \frac{{h}^{3}}{8 {c}_{Ω2}^{2}} {φ}_{i} {φ}_{j} & if ( {ξ}_{p} , {η}_{q} , {ζ}_{r} ) ⋐ Ω 2\end{matrix} \qquad ( 12 )$$

where Ω1 and Ω2 are domains containing elements divided by the sea bottom. This method can be interpreted as a kind of weighting using the spatial distribution of velocity as weighting for the velocity component. If we apply only one component in an element at the sea bottom, whether we select the water velocity or the subsurface velocity, the value of the mass matrix is one of the two extremes. Thus, instead of taking an extreme value, we use a moderate value reflecting the two velocities.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A seismic imaging method comprising :
obtaining a modeling parameter for a wave equation by updating the modeling parameter iteratively in the direction of minimizing a residual function regarding an error between modeling data and measured data, wherein the modeling data is a solution of the wave equation to which a coefficient matrix obtained from the modeling parameter has been applied, and the measured data has been measured by a plurality of receivers,
wherein the coefficient matrix is calculated from a mass matrix obtained according to the contour of the sea bottom within a global grid near the sea bottom.

2. The seismic imaging method of claim 1, wherein the mass matrix is obtained by applying a numerical integration method to two domains, the first domain being an upper medium above the sea bottom and the second domain being a lower medium below the sea is bottom.

3. The seismic imaging method of claim 2, wherein the numerical integration method is Gaussian Quadrature Integration Method.

4. A 3-dimensional seismic imaging method of claim 3.

5. A computer-readable recording medium storing a computer-readable program for executing the method of claim 4.

6. The seismic imaging method of claim 1, wherein the obtaining the modeling parameter comprises:
Calculating a coefficient matrix of the wave equation from a modeling parameter;
solving the wave equation with given source data to obtain a modeling data;
obtaining a residual function regarding a residual between the measured data and the modeling data; and
updating, if a value of the residual function is greater than a predetermined value, the modeling parameter of the wave equation in the direction of minimizing the residual function, and outputting, if the value of the residual function is smaller than the predetermined value, the modeling parameter as a final output value;
wherein calculating the coefficient matrix includes calculating a mass matrix obtained by applying a numerical integration method to two domains, the first domain being an upper medium above the sea bottom and the second domain being a lower medium below the sea bottom.

7. The seismic imaging method of claim 6, wherein the numerical integration method is Gaussian Quadrature Integration Method.

8. A computer-readable recording medium storing a computer-readable program for executing the method of claim 7.

9. A 3-dimensional seismic imaging method of claim 8.
